(19) United States
(12) Patent Application Publication
(10) Pub. No.: US 2011/0167710 A1
(43) Pub. Date: Jul. 14, 2011

(54) Trap

(76) Inventor: Donald R. Boys, Aromas, CA (US)

(21) Appl. No.: 12/687,386

(22) Filed: Jan. 14, 2010

(51) Int. Cl. A01M 23/26

(52) U.S. Cl. 43/92; 43/88

(57) ABSTRACT

A trap includes a generally U-shaped spring element with a first and a second arm extending in the same general direction, the arms ending in a set of jaws, the spring element implemented such that with the spring relaxed the jaw set is closed, a trigger linkage comprising a first link pivoted on the first arm of the spring element and a second link pivoted on the second arm of the spring element, with the first link positioned in front of the second link toward the jaw set, and pivoted to the second link at a point between the arms about equidistant from each arm, wherein the length of the links is such that, with the spring element relaxed the linkage is folded, and with the spring element arms urged apart with the arms approximately parallel, the links are essentially collinear, a constraint mechanism rigidly attached to the second link and having an extension over the first link, such that, with the spring element positioned horizontally, the linkage mechanism is constrained to a specific magnitude of folding downward, but is not constrained in folding upward except by the closing of the jaw set, and a paddle attached to an underside of one of the first link and extending toward the jaw set, the paddle having an upward curvature at an end away from the first link and closer to the jaw set.

### BACKGROUND OF THE INVENTION

1. Field of the Invention

The present invention is in the field of small-animal traps, and pertains more particularly to a spring trap for killing gophers and other tunneling pests.

2. Description of Related Art

Gophers and other tunneling rodents are an expensive and pervasive problem in many parts of the world, and many homeowners and managers of parks and golf courses, for example, wage war on these pests on a continuing basis.

There are commercially available gopher traps of many sorts, and many have been the subject of patent applications, but it is common experience in the art that gophers remain hard to trap, and typically a trap may have to be set several times for each success in killing a gopher.

Accordingly what is needed in the art is a simple, inexpensive gopher trap that has a higher rate of success than traps in the current art.

### BRIEF SUMMARY OF THE INVENTION

The inventor has recognized certain facts regarding rodents, particularly gophers, and habits of these animals in closing opening into their underground burrows. The inventor has also recognized certain failures of commercially available traps, and a long, unmet need for an effective rodent trap, and accordingly has provided a trap, comprising a generally U-shaped spring element with a first and a second arm extending in the same general direction, the arms ending in a set of jaws, the spring element implemented such that with the spring relaxed the jaw set is closed, a trigger linkage comprising a first link pivoted on the first arm of the spring element and a second link pivoted on the second arm of the spring element, with the first link positioned in front of the second link toward the jaw set, and pivoted to the second link at a point between the arms about equidistant from each arm, wherein the length of the links is such that, with the spring element relaxed the linkage is folded, and with the spring element arms urged apart with the arms approximately parallel, the links are essentially collinear, a constraint mechanism rigidly attached to the second link and having an extension over the first link, such that, with the spring element positioned horizontally, the linkage mechanism is constrained to a specific magnitude of folding downward, but is not constrained in folding upward except by the closing of the jaw set, and a paddle attached to an underside of one of the first link and extending toward the jaw set, the paddle having an upward curvature at an end away from the first link and closer to the jaw set.

In one embodiment the constraint mechanism comprises a threaded opening and a threaded screw through the opening, such that turning the screw in the threaded opening sets a dimension that the trigger linkage may fold downward. Also in one embodiment, with the links of the trigger linkage collinear and the jaws open, the point of pivot of the first link to the second link is below a line drawn between the pivot point of the first link to the first arm and the pivot point of the second link to the second arm, and the constraint mechanism is implemented to constrain the links to be collinear but not to allow folding downward, such that when the trap is set with the links collinear force from the arms of the spring element will urge the trigger linkage to fold downward, thereby keeping the trap set.

In some embodiments the spring element is formed of metal wire or rod, and is heat treated after being formed to exhibit a desired spring rate, and in some other embodiments the spring element is formed of flat metal strip, providing a spring element in the form of a leaf spring, and the element is heat treated after forming to acquire a desired spring rate.

In some embodiments the first and the second link, at the points where the links are to pivot to the arms, are formed to have a slot to engage the respective arm of the spring element, such that the angle of the links to the arms may change in folding without binding, and in some embodiments the first and the second links are constrained to a particular position on the respective arms of the spring element by plastic or metal clips applied to the arms before and after the links.

### BRIEF DESCRIPTION OF THE SEVERAL VIEWS OF THE DRAWINGS

FIG. 1 is an isometric view of a gopher trap in an embodiment of the invention, shown set.

FIG. 2 is an isometric view of the trap of FIG. 1, shown tripped.

FIG. 3a is an elevation view of a trigger mechanism for the trap of FIGS. 1 and 2.

FIG. 3b is a plan view of the trigger mechanism of FIG. 3a.

FIG. 4 is a force diagram for approximating the force necessary to spring the trap once it has been set.

### DETAILED DESCRIPTION OF THE INVENTION

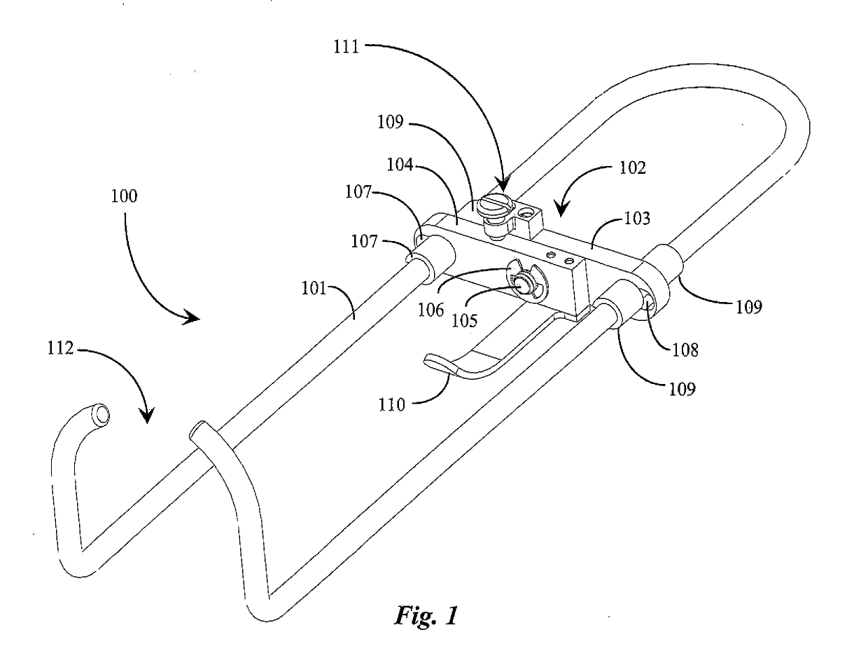

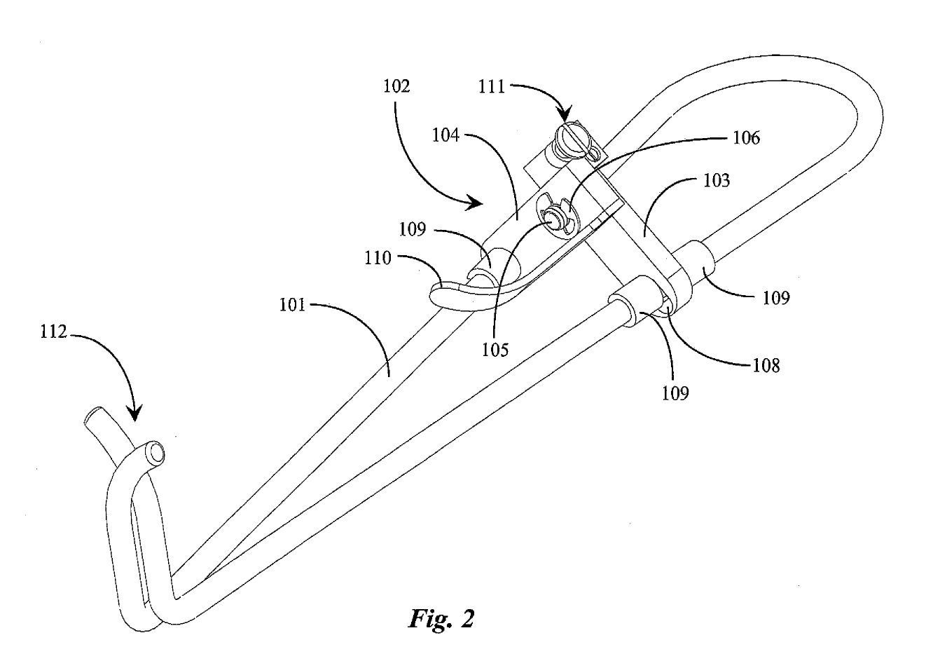

FIG. 1 is an isometric view of a gopher trap in an embodiment of the invention, shown set, and FIG. 2 is an isometric view of the trap of FIG. 1 shown tripped. The trap as shown in FIGS. 1 and 2 comprises a tempered spring element 101 having generally a “U” shape with two extended arms, with ends of the arms formed to produce jaw 112. The trap in FIG. 1 is shown in a “set” condition with the spring element, therefore the jaw, urged open. In a normally released and relaxed condition as shown in FIG. 2 the jaws are closed.

The jaw is held open as shown in FIG. 1 by a trigger linkage 102 comprising a first link 104 pivoted about one arm of spring element 101 on one side by a slot 107 and a second link 103 pivoted about the opposite arm of spring element 101 by a slot 108. The slots are necessary as opposed to round openings, to allow for closing of the spring element and the jaws as evidenced in FIG. 2.

Links 103 and 104 are joined by a pivot shaft 105 held by a retainer clip 106, such that the links may rotate relative to one another and the arms of the spring element. The links are constrained in position relative to the arms of spring element 101 in this example by plastic clips 109. These clips may be implemented in any one of a number of ways, and the function may also be provided by weld spots, collars, and in other ways. Elements 109 are simply to hold the trigger linkage in position relative to the spring element arms once the links are placed in a proper position.

Referring now to FIG. 2 trigger linkage 102 is shown tripped, that is, folded, allowing jaw 112 to close. The spring element is prepared and tempered to provide, in one embodiment, about 10 pounds of closing force when held open as in FIG. 1. This can be varied by the material choice, the diameter of the material, and by tempering treatment. In some embodiments the cross-section shape of the spring element may not be round as shown, but may be some other shape, such as a leaf spring, for example.

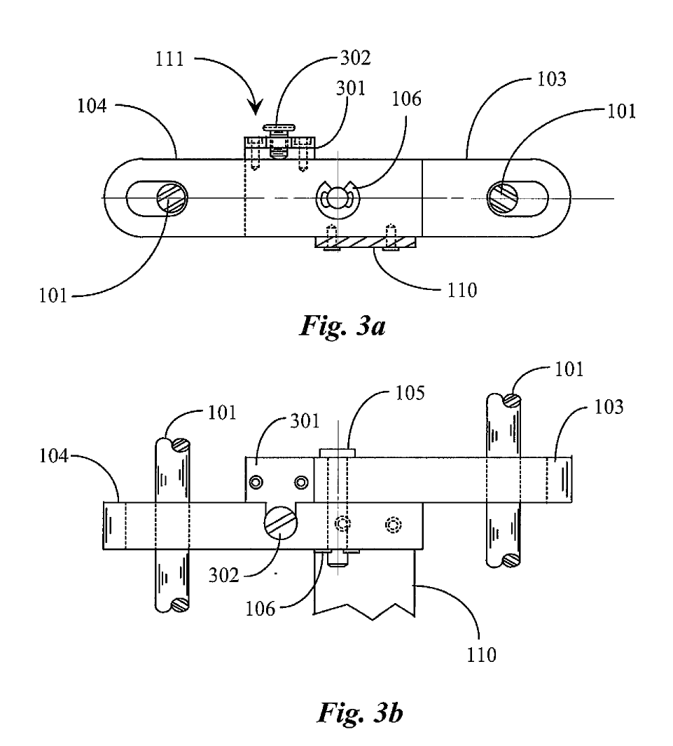

Mechanism 111 is an adjustable constraint that limits extent of folding of the trigger linkage in a downward direction. There is no similar constraint preventing folding in the upward direction, except the closing of the spring element. FIG. 3a is an elevation view of trigger linkage 102 and mechanism 111 viewing from the jaw viewpoint, and FIG. 3b is a plan view of the trigger linkage.

Trigger linkage 102, without constraint, will fold either upward or downward urged by the force of the arms of spring element 101, unless the linkage is perfectly horizontal; that is, without initial deflection either upward or downward, and the pivot axes through the slots and arms, and through shaft 105, are linearly aligned, as shown in FIG. 3a. Referring again to FIG. 3a, constraint mechanism 111 is shown as a bracket 301 bolted to link 103 and having an extension over link 104 with a threaded opening for an adjustment screw 302, in this example a slotted screw, and preferably a Nylock screw that will maintain its rotary position once adjusted. Paddle 110 is also indicated as fastened to the bottom of link 104.

Mechanism 111 may be adjusted with screw 302 set at a predetermined position to contact link 104 in a manner that the trigger linkage may fold in the downward direction a marginal amount, such that, for example, the axis of pivot shaft 105 may be a few thousands of an inch below a line through the centerline of the arms of spring element 101. With adjustment screw 302 thusly adjusted, and assuming the trap is sprung as shown in FIG. 2, a user may grasp the spring element arms near jaw 112, and open the jaw against the spring element. This motion will cause the trigger linkage to straighten. When the trigger linkage is straight, the user may urge it past center the small amount allowed by mechanism 111, and the trap will remain set as shown in FIG. 1. It will remain set because the trigger linkage, having its center pivot at shaft 105 marginally below center, will try to fold downward by force of the spring element. Screw 302 of mechanism 111 will prevent any further downward folding. In this arrangement the trap is set and will remain set until and unless some circumstance causes the trigger linkage to fold upward past center, under which circumstance the spring element will quickly cause the linkage to continue to fold upward until the jaw is closed. That is, the trap will revert to the circumstance shown in FIG. 2.

Springing the trap, then, is caused by any action that causes trigger linkage 102 to fold upward enough to pass center. This is a purpose of paddle 110. Paddle 110 is fastened to the underside of link 104 in this example, and extends forward toward jaw 112. Near the end furthermost toward jaw 112, paddle 110 is curved in an upward direction. When trap 100 is set and placed in a gopher run, with jaw 112 into the run away from the opening into the run through which the trap may be inserted, paddle 110 is presented toward a gopher that may be drawn to the opening to close it. It is known that gophers seek to close openings into their runs by pushing dirt into the opening to close the opening. The present inventor has deduced thusly that it is not the gopher that may triggers a trap, but the dirt that gopher pushes forward into the opening. The placement and curvature of paddle 110 is such that dirt pushed by a gopher under the paddle will cause the paddle to translate upward, which will in turn translate link 104 upward, moving the center pivot past center, triggering the trap to quickly close jaw 112, capturing or killing the gopher.

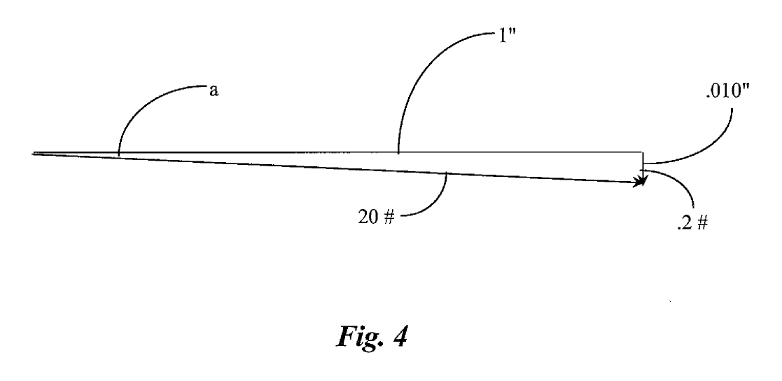

It is desirable that the trigger be what may be termed in the at a “hair” trigger. That is, that it require only a very small force against the paddle to trigger the trap to close. The necessary force may be calculated by assuming a dimension of the center pivot below center, dimensions for the links, and a force exerted by spring element 101. FIG. 4 is a force diagram under these assumptions. Assuming a force exerted of twenty pounds by the spring element in the set position along the direction of link 104, with the center pivot 0.010″ below center, the angle alpha is known by the sine of the angle being 0.010/1, or 0.010. Angle a is then about 0.57 degrees. The force exerted by the spring element against screw 302 will be about 0.01×20=0.2 pounds, or about 3.2 ounces.

In preferred embodiments screw 302 and its threaded opening are provided with a fine thread, so sensitive adjustments may be made. In practice, once screw 302 is adjusted so the trap remains set, the screw may be rotated until the trap springs, then reset a small amount, so the trigger is as sensitive as may be provided under the circumstances. A very small upward force on paddle 110 under this circumstance will spring the trap.

It is to be understood that spring elements may be prepared and used provide a closing force in any desired range, from perhaps 5 pounds to more than fifty pounds under various circumstances. Dimensions of the spring element and the linkages may vary as well, as may the circumstances of setting the trap. The trap may be set by a user pulling the spring element arms apart and being sure the trigger linkage stays set by urging the linkage past center downward, but this manual operation may be difficult for some. Therefore a setting device is provided in one aspect that engages the spring element arms and allows a user to manipulate a pair of arms longer than the spring element arms, or otherwise provided with a mechanical advantage. Such a device may be made in a variety of ways, and in some cases may be hydraulically or pneumatically powered. One such device will serve for setting a number of traps over and over again.

The above forces and dimensions are exemplary only. It is also to be understood that many of the elements may be provided in a variety of ways. There are, for example a number of elements that might be used for elements 109 to fix the position of the trigger linkage along the arms of the spring element. Similarly there are a number of ways the pivots may be implemented, and a number of ways the linkage may be constrained to provide for setting the trap. In one variant, for example, the bore through the links for shaft 105 may be set to be a few thousandths of an inch below an action line drawn through the pivot points at the slots that engage the arms of the spring element. In this circumstance when the linkages are perfectly aligned, the spring element will urge the trigger linkage to fold downward. One of the links may be implemented so that the linkage may fold upward, but not downward past the links being aligned. In this arrangement the setting force is fixed, but there is no need for an adjustment screw.

In other aspects materials may be varied. In the embodiments described above the spring element is considered to be metal alloy that may be heat-treated after forming to shape to acquire a desired spring rate. In some embodiments the spring element may be plastic or some other material, and in some cases the spring element may not have arms that start as rod or wire, but may be of a flat aspect to produce a leaf-type spring. There are many possibilities.

In some alternative embodiments the spring element may have a coil at the end joining the arms, with the arms radiating outward from the coil. In some cases the arms may be joined to a spring coil by welding or some other fastening technique.

The adjustment screw allows sensitivity to be adjusted, which is also a good thing, because traps of this sort, exposed to the weather and used underground, may suffer marginal degradation changing the friction between parts, for example, changing thereby the force necessary to spring the trap. There are similarly other variables, such as the extent, width and curvature of paddle 110. The invention is limited only by the scope of the claims that follow.

1. A trap, comprising:
a generally U-shaped spring element with a first and a second arm extending in the same general direction, the arms ending in a set of jaws, the spring element implemented such that with the spring relaxed the jaw set is closed;
a trigger linkage comprising a first link pivoted on the first arm of the spring element and a second link pivoted on the second arm of the spring element, with the first link positioned in front of the second link toward the jaw set, and pivoted to the second link at a point between the arms about equidistant from each arm, wherein the length of the links is such that, with the spring element relaxed the linkage is folded, and with the spring element arms urged apart with the arms approximately parallel, the links are essentially collinear;
a constraint mechanism rigidly attached to the second link and having an extension over the first link, such that, with the spring element positioned horizontally, the linkage mechanism is constrained to a specific magnitude of folding downward, but is not constrained in folding upward except by the closing of the jaw set; and
a paddle attached to an underside of one of the first link and extending toward the jaw set, the paddle having an upward curvature at an end away from the first link and closer to the jaw set.

2. The trap of claim 1 wherein the constraint mechanism comprises a threaded opening and a threaded screw through the opening, such that turning the screw in the threaded opening sets a dimension that the trigger linkage may fold downward.

3. The trap of claim 1 wherein, with the links of the trigger linkage collinear and the jaws open, the point of pivot of the first link to the second link is below a line drawn between the pivot point of the first link to the first arm and the pivot point of the second link to the second arm, and the constraint mechanism is implemented to constrain the links to be collinear but not to allow folding downward, such that when the trap is set with the links collinear force from the arms of the spring element will urge the trigger linkage to fold downward, thereby keeping the trap set.

4. The trap of claim 1 wherein the spring element is formed of metal wire or rod, and is heat treated after being formed to exhibit a desired spring rate.

5. The trap of claim 1 wherein the spring element is formed of flat metal strip, providing a spring element in the form of a leaf spring, and the element is heat treated after forming to acquire a desired spring rate.

6. The trap of claim 1 wherein the first and the second link, at the points where the links are to pivot to the arms, are formed to have a slot to engage the respective arm of the spring element, such that the angle of the links to the arms may change in folding without binding.

7. The trap of claim 1 wherein the first and the second links are constrained to a particular position on the respective arms of the spring element by plastic or metal clips applied to the arms before and after the links.
